(19) United States
(12) Patent Application Publication
(10) Pub. No.: US 2015/0008271 A1
(43) Pub. Date: Jan. 8, 2015

(54) Injector Orifice Plate Filter

(71) Applicant: Caterpillar Inc., Peoria, IL (US)

(72) Inventor: David Clarence Mack, Peoria, IL (US)

(21) Appl. No.: 13/933,521

(22) Filed: Jul. 2, 2013

(51) Int. Cl. F02M 61/16

(52) U.S. Cl. CPC F02M 61/165; F02M 61/168
USPC 239/575; 29/428

(57) ABSTRACT

A hoop filter is adapted to protect a pressure control orifice plate in a common rail fuel injector from being plugged by contaminated fuel. Shaped in the form of a band, the filter is configured to engage the circumference of a pressure control orifice plate. For purposes of filtration, the orifice plate has a circumferential groove which intersects at least one internal orifice; the groove is externally covered by the body of the hoop filter. In one embodiment, the band-shaped hoop filter has small apertures adapted to filter out any particle having a size greater than 50 microns. In another disclosed embodiment, the hoop filter is a solid band-shaped edge filter without any apertures; instead the orifice plate periphery includes circumferentially spaced vertical grooves which interface with the bottom and top edges of the filter to restrict entry of contaminant particles.

### TECHNICAL FIELD

This disclosure relates generally to systems and methods for protecting common rail electronic fuel injection systems from potential damage by contaminated fuels. More particularly, the disclosure relates to fuel filters adapted to keep particulate matter from plugging orifices of fuel pressure control orifice plates used in fuel injectors of such systems.

### BACKGROUND

Common rail fuel injector systems are typically associated with internal combustion engines, and most often with diesel engines, for supplying fuel to power such engines. The injectors include needle valves moveable within nozzle pressure control chambers. Each needle valve is adapted to open and close a nozzle outlet for injecting fuel into a combustion cylinder in response to controlled pressure level changes within the nozzle pressure control chamber.

Typically, each fuel injector includes an injector body having a fuel inlet, at least one nozzle outlet, and a drain outlet. Each injector has disposed within its body a nozzle chamber in which a needle valve is adapted for rapid reciprocating movement. The nozzle chamber is subjected to high and low fuel pressure cycles managed by an electronic fuel pressure controller.

Each instance of injection of fuel into an engine piston cylinder must be accurately timed during the combustion cycle. For such purpose, fuel pressure is controlled by a solenoid-actuated two-way or three way valve to fluidly connect and disconnect the nozzle chamber with and from, respectively, a low-pressure drain outlet. Each injection of fuel into the combustion chamber occurs only when the valve is under high pressure. Each of such injection events ends when the valve is de-energized, as referenced and described in co-owned U.S. Pat. Nos. 7,331,329 (a three-way valve example) and 6,986,474 (a two-way valve example).

Fuel particulate contaminants may occasionally be introduced into fuels sourced from various origins for their ultimate introduction into the injectors. As such, fuel filters may serve the purpose of filtering out such particles so that the injectors, including their small chambers and orifices, remain free of debris. Such debris can otherwise clog the described internal parts of the injector, and deleteriously interfere with their accurate functioning.

Among common fuel filtration strategies used to filter out such particles, particular care must be given to managing pressure drops generally associated with the filtering of large fuel volumes, especially under higher loads when fuel flows through the injectors may be at their maximum volumes. For example, U.S. Pat. No. 5,423,489, assigned to Siemens, offers a fuel injection system having an internal filter adapted to filter 100% of the fuel being supplied into the injector. In extremely large engines, however, such approach may not be practical due to excessive pressure drops. In another example, WO2004070199A1, assigned to same company, provides a screen filter, albeit again adapted to filter 100% of the fuel being supplied to the injector.

To the extent that the most critical aspect of filtration may be at the interfaces of the control orifices in a fuel injector, and since the control orifices receive only 1 to 3% of total fuel supplied to an injector, an opportunity is presented to filter only the latter portion of the fuel injector system to avoid substantial fuel pressure drop though the injector. Of course a normal fuel tank filter may also be in place, apart from any filtering considerations at or within the fuel injector, per se.

### SUMMARY OF THE DISCLOSURE

One aspect of the disclosure includes a fuel injector configured to be responsive to fuel pressure controlled by an electronic fuel pressure controller having a control orifice plate. The control orifice plate may include at least one internal orifice, and may be formed to have an upper and a lower surface. A circumferential groove may extend about the exterior of the control orifice plate, and a hoop filter defining a wall may be juxtaposed tightly against, and extend about, the circumference of the orifice plate. The hoop filter may fully overlie the circumferential groove, and the internal orifice may intersect the groove.

In another aspect of the disclosure, a fuel injection pressure control system may have an electronic fuel pressure controller, and may include a fuel injector having at least one control orifice plate configured to be responsive to fuel pressure controlled by the electronic fuel pressure controller. The control orifice plate may include at least one internal orifice, and may be formed having an upper and a lower surface. A circumferential groove may extend about the exterior of the control orifice plate, and a hoop filter having a wall may be juxtaposed tightly against, and extend about, the circumference of the orifice plate. The hoop filter may overlie the circumferential groove, and the internal orifice may intersect the groove.

In a further aspect of the disclosure, a method of manufacturing a hoop filter configured for filtering a circular orifice plate of a fuel injector may include forming the filter as a high temperature metal ring defining a continuous wall, and laser etching a plurality of radially extending apertures through the wall. The apertures may be formed such that any given aperture dimension is no larger than 50 microns. The hoop filter may be tightly banded about the circumference of the orifice plate, which may include a circumferential groove.

### BRIEF DESCRIPTION OF THE DRAWINGS

FIG. 1 is a cross-sectional view of an electronically actuated common rail fuel injector including an orifice plate filter.

FIG. 2 is a control orifice portion of the common rail fuel injector of FIG. 1, showing an orifice plate configured to include a filter (shown in phantom) of the present disclosure.

FIG. 3 is a perspective view of the orifice plate, interfacing with a hoop ring filter sized and adapted for use with the orifice plate of FIG. 2.

FIG. 4 is an alternate embodiment of a hoop ring filter, shown situated about a modified orifice plate.

### DETAILED DESCRIPTION OF DISCLOSURE

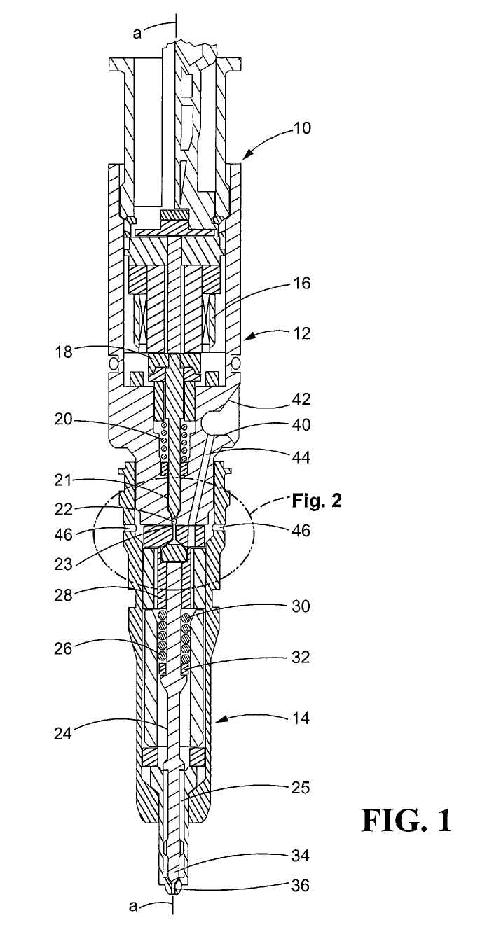

Referring initially to FIG. 1, a common rail fuel injector 10 includes an upper body portion 12 and a lower body portion 14, each portion 12, 14 containing various components to be described. The fuel injector 10 includes an axis “a-a” about which the upper and lower body portions 12, 14 are oriented. Although the upper and lower body portions 12, 14 are shown as separate structures, albeit secured together, they could alternatively be formed as a single unitary structure.

In the upper body portion 12 of the fuel injector 10, an electronic actuator 16 may be actuated by either a solenoid or piezo electronic actuating system, as may be appreciated by those skilled in this art. The actuator 16 may be directly coupled to an armature 18. As such, the actuator 16 may be adapted for mechanically moving a fuel pressure control valve 22 against the force of a control valve biasing spring 20. In the fuel injector 10, the spring 20 normally biases a control valve pusher 21 against the control valve 22 to hold the control valve 22 into its closed position when the actuator 16 is de-energized. Conversely, when energized the actuator 16 is adapted to effectively raise the control of 22 from its seat 23 against the force of the spring 20.

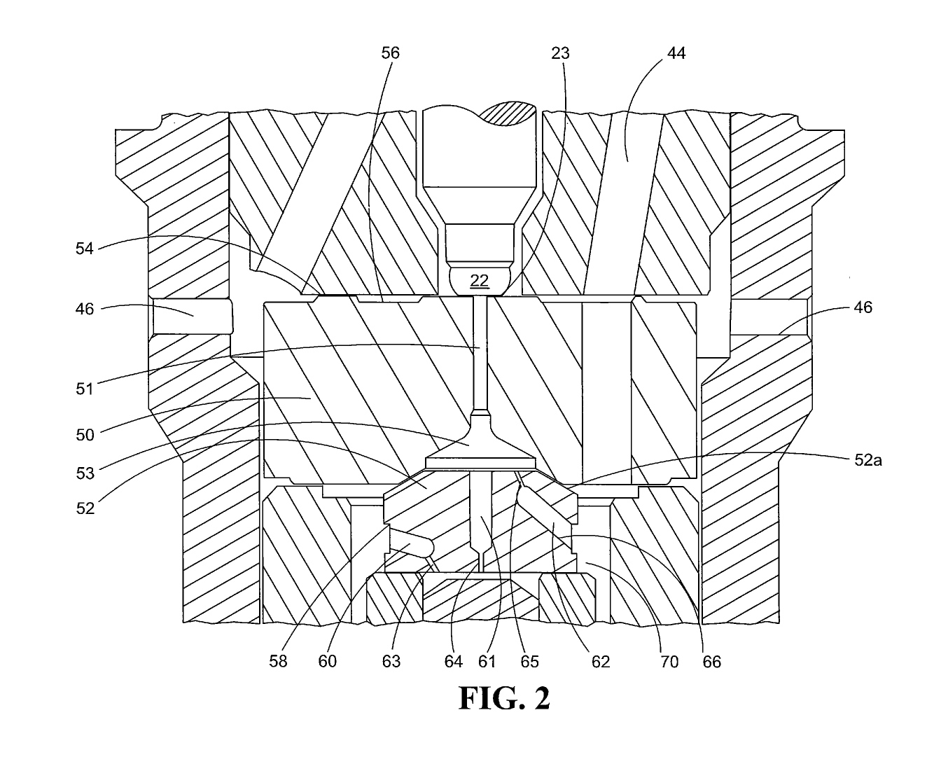

Referring now to FIG. 2, the seat 23 may be so-called “flat seat” having a planar surface, as opposed to a conical seat most often associated with a poppet valve, for example.

Referring again to FIG. 1, a hydraulic pressure responsive needle valve 24 is provided in the lower body portion 14 of the fuel injector 10. The needle valve is contained within a nozzle pressure control chamber 25, and its movement is normally directly biased by a needle valve spring 26. However, hydraulic forces are controlled so as to permit reciprocating movement of the needle valve 24 against the force of spring 26 within a needle guide 28 for management of combustion-sensitive timed injection events. For this purpose, the spring 26 is situated between an axially facing annular bearing surface 30 of the needle guide 28 and an opposed lower similarly facing annular bearing surface 32 on the needle valve 24.

The bottom or lower end 34 of the needle valve 24 is adapted to physically engage, i.e. to close against, a control nozzle outlet 36 between timed injection events. Although movement of the needle valve 24 may be hydraulically induced against the force of spring 26, the pusher 21 and pressure control valve 22 are electro-mechanically actuated against the force of the spring 20, as will be appreciated by those skilled in the art.

Continuing reference to FIG. 1, the fuel injector 10 includes a fuel inlet 40 having a seat 42 adapted to accommodate a conventional fuel quill (not shown). The fuel inlet 40 accommodates a fuel supply passage 44 under extremely high pressure, for example, in a range of approximately 200 to 250 bars. As such, fuel under pressure completely fills all internal openings and/or passages within the injector whenever low-pressure drain outlets 46 are closed, i.e. between injection events, as will be appreciated by those skilled in the art.

Referring now to FIG. 2, under the pressure control valve 22 are situated a spacer plate 50 and an orifice plate 52. The spacer plate 50 contains a single vertical drain passageway 51 which has a flared bottom 53, permitting the passageway 51 to facilitate rapid interconnection between the drain outlets 46 and a plurality of orifices in the orifice plate 52 along with their associated fuel supply passageways. Thus, although the passageway 51 only directly physically interfaces one fuel supply passageway 61 and one orifice 65 within the orifice plate 52, the passageway 51 is hydraulically interconnected with all of the fuel flow passageways 60, 61, and 62, and each of their respective orifices, 63, 64, and 65.

As part of the fuel pressure control system utilized to manage injection events, and configured to interact with the orifice plate 52, the spacer plate 50 may include a series of noncontiguous sealing lands 54 and grooves 56 on its upper and lower surfaces to accommodate fuel pressures and control fuel flow volumes within the variously described components. The orifice plate 52 may be configured generally as a cylinder or disc. In the embodiment shown, the orifice plate 52 also includes an upper frustoconical portion 52a, the latter being configured for cooperation with the spacer plate 50.

The orifice plate 52 is exposed to only a small percentage of the total amount of fuel delivered to the fuel injector 10. Thus, a small or “control” amount of fuel is received through the fuel supply passageways 60, 61, and 62, and their respective orifices 63, 64, and 65 for purposes of managing fuel pressure. For this purpose the fuel supply passage 44 is in direct communication with the circumference of the orifice plate 52.

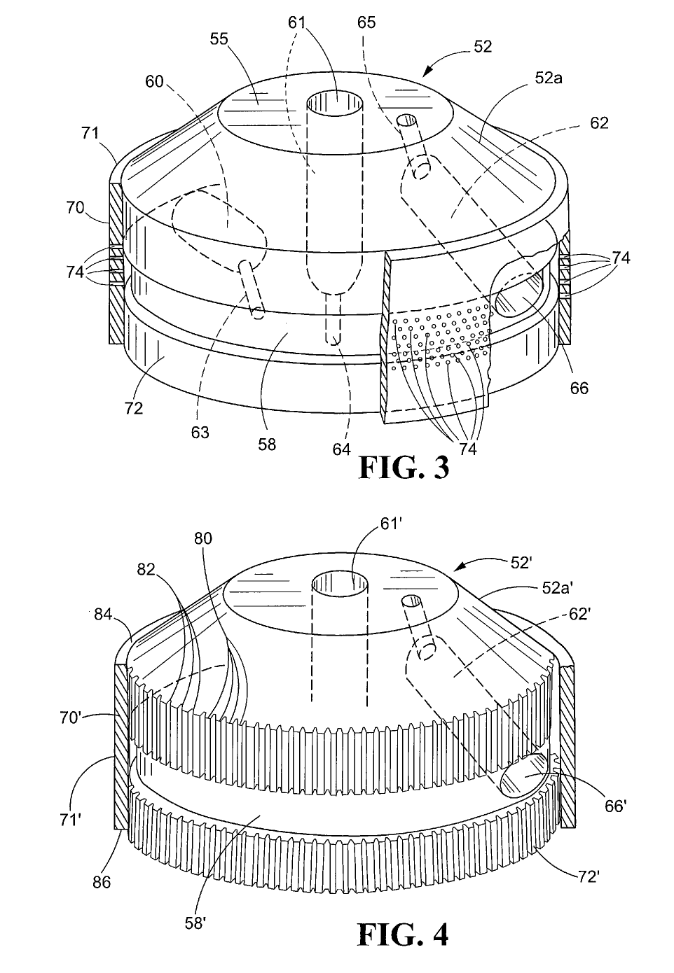

Referring now also to FIG. 3, to the extent that there may be an issue of plugging any one of the relatively small orifices 63, 64, 65 with particulates that may be in a given supply of contaminated fuel, a hoop filter 70, which may be formed of a relatively thin cylindrical wall 71, may be tightly installed about the circumference 72 of the orifice plate 52. The hoop filter 70 may be installed by a shrink fit manufacturing operation, as just one example. A series of small apertures 74 may be provided through band style hoop filter, as shown, to filter control oil that first passes from the fuel supply passage 44 into a groove 58 formed in the circumferentially extending side of the orifice plate 52. Thus, the plurality of spaced apertures may extend radially through the cylindrical wall 71. In the disclosed embodiment, the apertures may have a largest dimension of no greater than 50 microns to filter out any particulates.

The apertures 74 may be provided throughout the entire hoop filter 70, or may be strategically located in an area of the hoop filter situated immediately over the groove 58 as disclosed herein. In FIGS. 2 and 3, the orifice plate 52 includes the described plurality of fuel supply passageways 60, 61, 62, each leading to its respective control orifice 63, 64, and 65, as shown. In the disclosed embodiment, the relatively larger fuel supply passageways are depicted as volumes adapted to aid in the control of fuel system pressure. Each orifice and associated supply passageway is dimensioned so as to avoid fuel flow impedance issues, such as viscosity and other hydrostatic phenomena, as those skilled in the art will appreciate.

Each individual orifice 63, 64, and 65 is interconnected with at least one orifice supply passageway 60, 61, and 62, respectively, as shown. The relatively larger fuel flow passageways may be sized and/or dimensioned to accommodate larger fuel volumes to avoid unintended pressure drops; indeed, for optimal fuel pressure management, all pressure drops will ideally occur only within the orifices, which are intentionally designed to be considerably smaller than their associated fuel supply passageways, as shown most clearly in FIGS. 2 and 3. Any specific information relative to exact sizing and/or orientation of the orifices and their fuel supply passageways is beyond the scope of this disclosure.

Referring now to FIG. 4, an alternate embodiment of the orifice plate 52 (FIG. 3) is shown as orifice plate 52′. In this embodiment, the circumference of the orifice plate contains a similar circumferential groove 58′, but also contains a plurality of circumferentially spaced vertical grooves 80 and vertical lands 82. The latter cooperate with a hoop filter 70′ to filter out any contaminant particles. The hoop filter 70′ in this case is defined by a continuous circumferential band containing no apertures, unlike the hoop filter 70 of FIG. 3. As such, the filtration takes place at upper and lower extremities or edges 84, 86 of the hoop filter 70′, i.e. between the grooves 80, lands 82, and the tightly banded structure of the hoop filter 70′ when positioned tightly about the circumference of the orifice plate 52′. In the disclosed embodiment, such defined filter openings may be adapted to permit fuel flow and yet restrict any contaminant particle having any dimension greater than 50 microns.

Although the embodiments described herein reflect particular shapes and dimensional aspects, other embodiments will fall within the spirit and scope of this disclosure. For example, the above-described system addressed a circular orifice plate 52. However, the orifice plate 52 may be square shaped, hexagonal, octagonal, or have any other shape desired. Moreover, although the discussions herein have been limited to fuel contaminants having a greatest particle dimension of no more than 50 microns, some systems may require protection from fuel contaminant particles smaller than 50 microns. The latter filtration demands are also believed to fall within the scope of this disclosure.

### INDUSTRIAL APPLICABILITY

The disclosed fuel injector 10 and its associated injector orifice plate filter 70 will find applicability in any fuel injection system having a high pressure common rail fuel source, including cam actuated fuel injectors and hybrids. Although the present disclosure may find particular applicability for fuel injectors utilizing two-way valves, it may also find potential applicability in fuel injectors that utilize three-way valves.

In operation, fuel enters into the fuel inlet 40 and travels into the fuel supply passage 44. During an injection event at the control nozzle outlet 36, the low-pressure drain outlets 46 are closed, and the springs 20 and 26 are biased upwardly from their respective pusher 21 and needle valve 24 components. At the end of any given fuel injection event, the electronic actuator 16 raises the armature 18, releasing the pressure control valve 22 from its seat 23, which in turn releases fuel system pressure and causes the low-pressure drain outlets 46 to open. It will be appreciated by those skilled in the art, that although the pressure control valve 22 is electromechanically actuated, the bottom end 34 of the needle valve 24 opens and closes against the control nozzle outlet 36 strictly by hydraulic pressure forces against a mechanical spring.

During sequences of injection events, the hoop filter 70 may be effective to filter out fuel contamination particles having any dimension larger than apertures 74. Thus, for example as disclosed, the apertures 74 may be sized to be no larger than 50 microns.

A method of providing a hoop filter 70 configured for a circular orifice plate of a fuel injector may include forming a physical hoop structure by, for example, stamping. For example, the method may include forming the hoop filter in a shape of a cylindrical ring having a continuous wall, and laser etching a plurality of radially extending apertures through the wall, such that any given aperture dimension is no larger than 50 microns. As a final step, the method may include tightly fitting the hoop filter about the circumference of the orifice plate.

A method of providing the alternate hoop filter 70′ may include forming a plurality of circumferential axially oriented grooves 80 and lands 82 in the circumference 72′ of the orifice plate 52′, and then forming the hoop filter 70′ without apertures; then tightly banding the hoop filter about the circumference 72′ of the orifice plate 52′ to provide filtration at the upper and lower edges 84 and 86, respectively, the filtration apertures being created by the hoop filter 70′ and the grooves 80, and the filtration apertures being no greater than 50 microns in their largest dimension.

What is claimed is:

1. A fuel injector including a control orifice plate configured to be responsive to fuel pressure controlled by an electronic fuel pressure controller, comprising:
the control orifice plate including at least one internal orifice, the plate having an upper and a lower surface;
a circumferential groove extending around the exterior of the control orifice plate; and
a hoop filter defining a wall juxtaposed tightly against, and extending about, the circumference of the orifice plate, wherein the hoop filter is adapted to overlie the circumferential groove;
wherein the at least one internal orifice intersects the groove.

2. The fuel injector of claim 1, wherein the hoop filter comprises a plurality of spaced apertures extending radially through the cylindrical wall.

3. The fuel injector of claim 2, wherein the apertures are medially positioned to overlie the circumferential groove of the orifice plate.

4. The fuel injector of claim 1, wherein the hoop filter is shrunk fit to the circumference of the orifice plate.

5. The fuel injector of claim 2, wherein any given aperture has a largest dimension of 50 microns or less.

6. The fuel injector of claim 1, wherein the orifice plate comprises a circumference having a plurality of spaced vertical lands and grooves, and the hoop filter comprises a continuous circumferential band about the orifice plate.

7. The fuel injector of claim 6, wherein the hoop filter band interfaces with each adjacent pair of lands and grooves to define an aperture, wherein a plurality of apertures are thereby provided at circumferentially extending upper and lower extremities of the cylindrical hoop filter band.

8. The fuel injector of claim 6, wherein the hoop filter band is shrunk fit to the circumference of the orifice plate.

9. The fuel injector of claim 6, wherein any given aperture has a largest dimension of 50 microns or less.

10. A fuel injection pressure control system having an electronic fuel pressure controller, comprising:
a fuel injector having at least one control orifice plate configured to be responsive to fuel pressure controlled by the electronic fuel pressure controller;
the control orifice plate including at least one internal orifice, the plate having an upper and a lower surface;
a circumferential groove extending around the exterior of the control orifice plate; and
a hoop filter defining a wall juxtaposed tightly against, and extending about, the circumference of the orifice plate, wherein the hoop filter is adapted to overlie the circumferential groove;
wherein the at least one internal orifice intersects the groove.

11. The fuel injection pressure control system of claim 10, wherein the hoop filter comprises a plurality of spaced apertures extending radially through the cylindrical wall.

12. The fuel injection pressure control system of claim 11, wherein the apertures are medially positioned to overlie the circumferential groove of the orifice plate.

13. The fuel injection pressure control system of claim 10, wherein the hoop filter is shrunk fit to the circumference of the orifice plate.

14. The fuel injection pressure control system of claim 11, wherein any given aperture has a largest dimension of 50 microns or less.

15. The fuel injection pressure control system of claim 10, wherein the orifice plate comprises a circumference having a plurality of spaced vertical lands and grooves, and the hoop filter comprises an apertureless continuous circumferential band about the orifice plate.

16. The fuel injection pressure control system of claim 15, wherein the hoop filter band interfaces with each adjacent pair of lands and grooves to define an aperture, wherein a plurality of apertures are thereby provided at circumferentially extending upper and lower extremities of the cylindrical hoop filter band.

17. The fuel injection pressure control system of claim 15, wherein the hoop filter band is shrunk fit to the circumference of the orifice plate.

18. The fuel injection pressure control system of claim 15, wherein any given aperture has a largest dimension of 50 microns or less.

19. The fuel injection pressure control system of claim 15, wherein the vertical grooves are laser etched into the circumference of the orifice plate.

20. A method of manufacturing a hoop filter configured for a circular orifice plate of a fuel injector, comprising:
forming a hoop filter in the shape of a ring having a continuous wall;
laser etching a plurality of radially extending apertures through the wall, such that any given aperture dimension is no larger than 50 microns; and
tightly fitting the hoop filter about the circumference of the orifice plate.
